(19) United States
(12) Patent Application Publication
(10) Pub. No.: US 2017/0129274 A1
(43) Pub. Date: May 11, 2017

(54) MAILER METHOD AND APPARATUS

(71) Applicant: INLINE GRAPHIC SOLUTIONS LTD, Amersham (GB)

(72) Inventors: Paul PRICE-STEPHENS, Loudwater (GB); Martin SIMMONS, Loudwater (GB)

(21) Appl. No.: 15/348,530

(22) Filed: Nov. 10, 2016

(30) Foreign Application Priority Data
Nov. 10, 2015 (GB) 1519859.1

(51) Int. Cl. B43M 3/02; B43M 5/04; B65D 27/14

(52) U.S. Cl. CPC B43M 3/02; B65D 27/14; B43M 5/042

(57) ABSTRACT

A mailer can include an envelope and an enclosure. A method can include: a) providing a blank with envelope and enclosure portions connected by a joint; b) folding and securing the blank such that the envelope portion forms a pouch, the pouch substantially containing the enclosure portion, the pouch being open at one end and having major surfaces, one major surface including the joint at or adjacent the open end, and another major surface including a closure flap extending from the open end beyond the joint; c) reversibly deflecting the flap away from the joint to thereby expose the joint; d) severing the joint while it is exposed; e) folding the closure flap and securing it to the one major surface to close the pouch and secure the enclosure within the pouch. An apparatus can be configured to carry out the above method.

### CROSS-REFERENCE TO RELATED APPLICATION

This application claims priority under 35 USC 119 to United Kingdom Application No. 1519859.1, filed 10 Nov. 2015. The entire disclosure of this prior application is incorporated herein by this reference.

### BACKGROUND

The present disclosure relates to a method of, and apparatus for, making a mailer. In particular the disclosure relates to the automated manufacture of secure mailers in which there is a reduced chance that an envelope part will not be matched to an enclosure part.

Although sending information by physical post is becoming less common, there are still many instances in which mailers are used to send information in this way. A mailer is a combination of an envelope, on which an address of an intended recipient will typically be indicated, and one or more enclosures which will include information to be provided to a recipient.

In many cases, the enclosures are not specific to the recipient, and so, if an envelope is incorrectly addressed, it is unlikely that there will be any significant problems, as the actual recipient will never know that the enclosures were not meant for them. However, if one or more of the enclosures are specific to the recipient, and more particularly if they include confidential information, for example, a bank statement, it is important that the correct envelope is matched with the correct enclosures. The recipient also has an expectation of how such a mailer should be presented, and the mailer should match that expectation as far as possible. Mailers were previously prepared by hand, so the mailer would typically be presented in the form of a traditional letter in an envelope. Automated preparation of mailers is possible, but the traditional format is typically retained as far as possible.

If the envelope and enclosure are formed in separate manufacturing streams, matching the two parts together can be achieved by including checking procedures into the mailer creation process and ensuring that the streams are suitably synchronised. However, with high speed throughput it is possible that the two streams may become out of synch and incorrectly addressed letters could be produced.

To avoid such problems, it has been found that, particularly for sensitive mailers which include confidential information, pre-printing the envelope and enclosure on the same piece of material, and only separating them when the enclosure is within the envelope, is particularly advantageous. However, the finished mailer does not resemble a hand filled envelope, as it is difficult to separate the enclosure and envelope after formation.

### BRIEF DESCRIPTION OF THE DRAWINGS

The invention will now be described, by way of example only, with reference to the following Figs. in which:

FIG. 1 shows a blank from which a mailer can be formed;

FIGS. 2a to 2e show a sequence of steps for forming the blank into a mailer;

FIGS. 3a to 3d show details of how one of the steps is achieved;

FIG. 4 shows a side view of apparatus suitable for carrying out one of the steps; and

FIG. 5 shows a schematic layout of apparatus suitable for forming a mailer.

### DETAILED DESCRIPTION

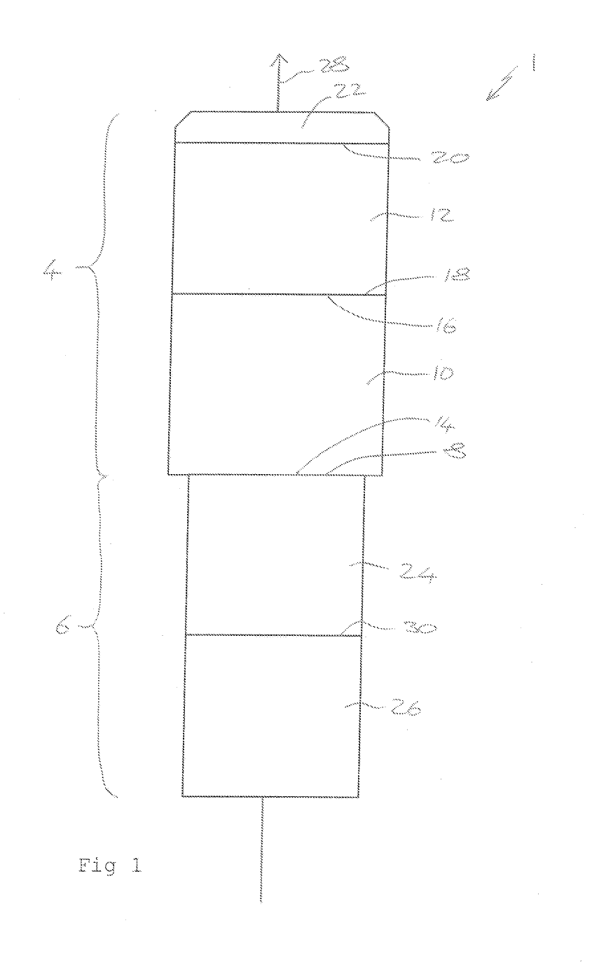

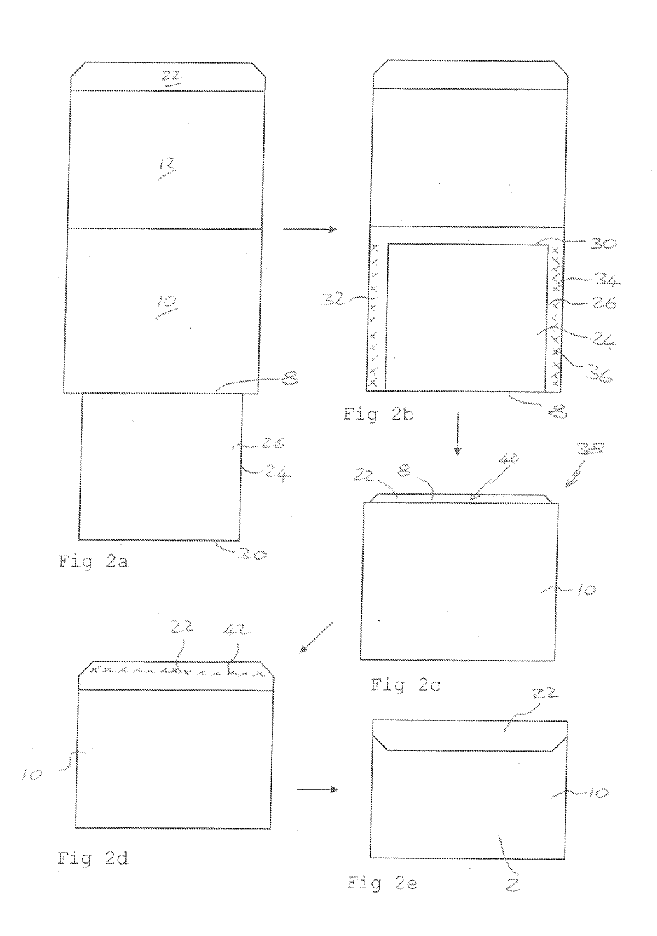

FIG. 1 shows an example of a blank 1 from which a mailer 2 (see FIG. 2e) can be formed. The blank 1 comprises an envelope portion 4 and an enclosure portion 6 which are joined together by a joint 8.

The envelope portion 4 comprises a first major surface 10 having the joint 8 at one edge 14 and coupled to a second major surface 12 at an opposing edge 16 by a fold line 18. A flap 22 extends from the second major surface from an edge 20 of the second major surface 12 opposite the fold line 18.

The enclosure portion 6 extends from the joint 8 away from the envelope portion and, in this example, comprises two enclosure portions 24 and 26 joined by a fold line 30, with enclosure portion 24 being connected to the joint 8.

The blank 1 comprises a plurality of elements—the flap 22, the first and second major surfaces 10,12 and the two enclosure portions 24, 26, which are arranged substantially along a first axis 28, and which are coupled by a joint 8, or fold lines 16, 20, 30, which extend substantially perpendicular to the first axis 28.

The envelope portion 4 is wider than the enclosure portion 6 in a direction perpendicular to the first axis 28.

FIGS. 2a to 2e show a sequence of steps for forming the blank 1 into a mailer 2. In FIG. 2a, the enclosure portion of the blank shown in FIG. 1 has been folded along fold 30, such that the two enclosure portions 24, 26 substantially overlie one another.

In FIG. 2b, the blank 1 of FIG. 2a has been folded along the joint 8, such that the folded enclosure portions 24, 26 are arranged on the first major surface 10. It should be noted that the enclosure portions do not extend beyond the first major surface 10, such that, at least at opposing edges 32, 34 substantially parallel with the first axis 28, the first major surface 10 is exposed and includes an adhesive 36.

In FIG. 2c, the blank 1 of FIG. 2b has been folded along the fold line 18 between the first and second major surfaces 10, 12. The adhesive 36 secures the edges 32, 34 to corresponding edges of the second major surface 12, such that a pouch 38 is formed which substantially contains the enclosure portion 6. The pouch 38 is open at one end 40, but is closed on the other sides by adhesive 36 and the fold line 18. In this configuration, the flap 22 extends beyond the joint 8.

In FIG. 2d, the joint 8 of FIG. 2c has been cut off to expose the flap 22 and to separate the envelope portion 4 from the enclosure portion 6, which is within the envelope portion 4. The flap 22 also includes an adhesive 42.

In FIG. 2e, the flap 22 of FIG. 2d has been folded onto the first major surface 10 and is secured there by the adhesive 42. This closes the pouch 38 and substantially secures the enclosure portion 6 within the envelope portion 4 to form the mailer 2.

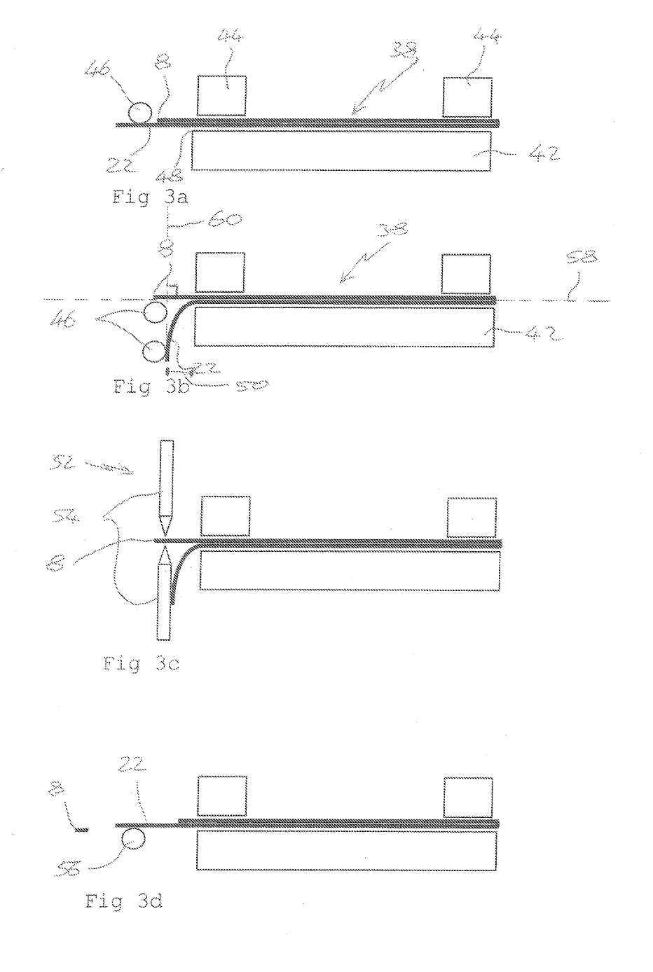

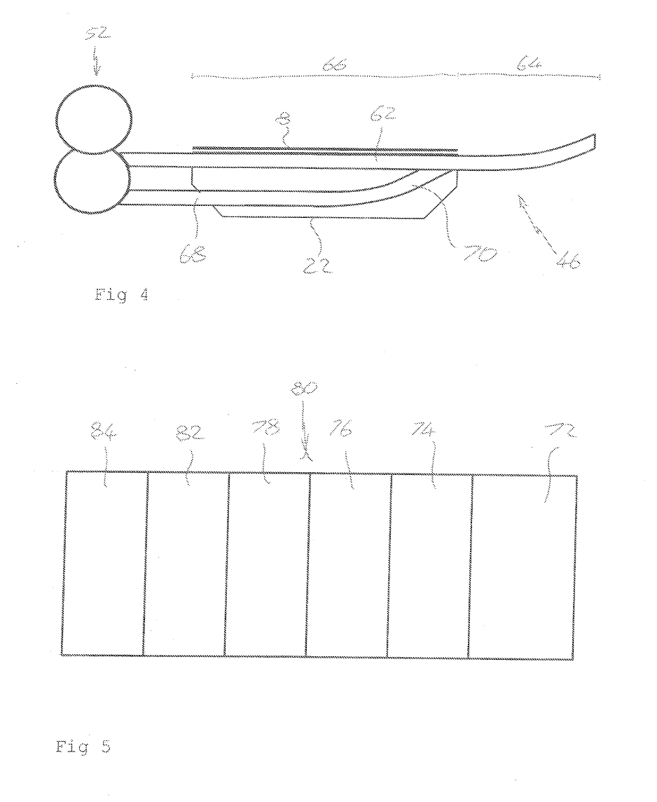

FIGS. 3a to 3d show the operation involved in moving from the pouch 38 of FIG. 2c to the arrangement of FIG. 2d.

The pouch 38 is arranged on a conveyor 42, in this case a vacuum conveyor, which uses suction to help retain the pouch 38 on the conveyor 42. Retention of the pouch 38 on the conveyor 42 is further assisted by the use of rollers 44, which are biased toward the conveyor 42. The pouch 38 is sandwiched between the conveyor 42 and the rollers 44, with the flap and joint extending beyond an edge 48 of the conveyor 42. A guide bar 46 contacts the flap 22 as the pouch 38 is moved by the conveyor 42 (in this case into the page). As the flap extends beyond the joint 8, it is possible for the guide 46, in this case comprising one or more rods with a circular cross section, to contact the flap 22 only.

In FIG. 3b, the movement of the pouch 38 by the conveyor 42 relative to the guide 46, and the shape of the guide 46, have caused the flap 22 to be reversibly deflected away from the joint 8.

The gap 50 between the guide 46 and the edge 48 of the conveyor 42 determines a radius of curvature through which the flap 22 and any associated part of the blank is bent. The size of the gap 50 can be adjusted, based on the physical characteristics of the material from which the blank is formed, to ensure that the radius of curvature and the rate at which bending occurs is not sufficient to create a permanent, visible, crease in the material. For typical paper materials used in mailer formation, a gap of between about 1 mm and 10 mm may be appropriate. A gap of less than about 5 mm may be advantageous, as it requires less material to be available for bending.

FIG. 3c shows the cutter 52, in this case a pair of cutting discs 54. The guide 46 has moved the flap sufficiently, so that the flap 22 can pass the cutter 52, but the joint 8 extends beyond and through the cutter 52 and so is cut off, or severed, as the pouch 38 is moved by the conveyor past the cutter 52.

In FIG. 3d, a return guide 56 has been used to return the flap 22 to its original configuration, and the joint 8 has been removed from the pouch 38.

A return guide 56 may not be required, but can be included if desired. The time for which the flap 22 is deflected may also determine whether a permanent, visible, crease is formed in the material. It is, therefore, desirable that the flap 22 is deflected only for the time required for the joint 8 to be removed by the cutter 52, and is then released.

As can be seen from FIG. 3b, the first and second major surfaces 10, 12 are substantially planar and lie parallel to a base plane 58. The flap 22 originally lay in this plane but has been deflected, so that a portion of the flap 22 lies in a deflected plane 60. The deflected plane is, in this case, substantially 90° offset from the base plane 58. A 90° deflection of the flap, and a gap 50 between the guide and the edge 48 of the conveyor 42 of about 5 mm, results in a minimum radius of curvature of about 5 mm.

FIG. 4 shows a side view of the guide 46. In this example, the conveyor (not shown) is moving the pouch 38 to the left of the page and towards the cutter 52. The guide 46 comprises a top rod 62, which provides a trapping portion 64, which contacts the flap 22 as the conveyor moves the pouch past the guide 46, and ensures that the flap 22 does not avoid a deflection portion 66 of the guide 46. The deflection portion 66 includes a lower rod 68, which is coupled to the top rod 62 and extends away from the top rod 26 in the direction of motion of the conveyor 42, and thereby provides a ramp 70 which gradually increases the deflection of the flap 22, until a full deflection is reached (as shown), at which point the lower rod 68 is arranged at a substantially constant distance from the top rod 62, until the cutter 52 is reached.

With reference to FIG. 5, a specific example of a method employing the principles of this disclosure could be as follows:

1. In a web section 72 take a web, or roll, of blank or pre-printed paper and load it into an unwinder to provide the stock.

2. If blank stock is being used, then unwind the web into a printing section 74, which includes a digital laser or inkjet system for personalisation.

3. If the roll of paper has been pre-printed and personalised, then step 2 can be skipped.

4. Then the web can be fed into a receiving section 76, where the following operations can take place in any order: Die cutting for shaping the product, creasing to assist in the folding process, perforating to allow the recipient to split items off, patching for creating windows in envelopes, kiss cutting, flexo inks for security features.

5. All the above processes may be intelligently selectable through a 2D barcode, which can be read by the apparatus, via a scanner, video or digital imaging system or the like, thus enabling each document produced to be unique.

6. Once the flat material is formed to the required specification, which may, for example, include a number of pages for the enclosure, the envelope profile, window aperture cut and a window patch added.

7. The product is then sheeted to the correct length for each piece to provide a blank 1.

8. The blanks then go into a forming section 78, including a folding system, which folds the enclosure portion to the appropriate format for the documents and envelope.

9. Once the internal document is folded, but before the envelope pouch is created, additional items such as ID cards, letters, bank cards or booklets can be added from, for example, friction feeders or windmill tip on, and may be held in place by static or glue in a content adding section 80. The content adding section 80 may be integrated into either of the receiving and forming sections 76, 78.

10. Then the item is glued with multiple hot glue lines, and then into a second folding system (for example a tipper plate) to seal, thus creating the envelope pouch with the documents inside still attached to the envelope. This arrangement means that there is no possibility of a mismatch between the envelope and enclosures.

11. In a cutting section 82, the envelope pouch is then transferred onto vacuum belts with top rollers applying a pressure to secure the pouch to the vacuum belt. As the pouch is moved by the conveyor, the unsealed flap of the envelope is guided down through substantially 90° by a guide rod arrangement. This keeps the flap clear of a cutter while exposing a joint to be cut by the cutter as the pouch is moved past on the conveyor. This allows the documents to be separated and released from the envelope, while remaining within the envelope.

12. In a finishing section 84, the envelope flap is then guided back up while having a line of peel-able glue added and finally ploughed over, thereby sealing the envelope flap.

Although this method includes specific examples of apparatus, it will be apparent to one skilled in the art that the scope of this disclosure is not so limited, and that alternative apparatus may be used.

The present disclosure provides a method of making a mailer, the mailer comprising an envelope and an enclosure. In one example, the method can comprise the steps of:
a) providing a blank comprising an envelope portion and an enclosure portion, the envelope portion connected to the enclosure portion by a joint;
b) folding and securing the blank such that the envelope portion forms a pouch, the pouch substantially containing the enclosure portion, the pouch being open at one end and having first and second major surfaces, the first major surface including the joint at or adjacent the open end, and the second major surface including a closure flap extending from the open end beyond the joint;
c) reversibly deflecting the flap away from the joint to thereby expose the joint;
d) severing the joint while it is exposed;
e) folding the closure flap and securing it to the first major surface to close the pouch and secure the enclosure within the pouch.

This method reversibly deflects the flap away from the joint to expose the joint and allow it to be cut. A reversible deflection is one which can be substantially undone without leaving any significant evidence that the deflection took place. For example, the deflection could be substantially within the elastic capabilities of the material being deflected, so that the material substantially returns to its original configuration when a biasing force is removed, leaving little, or no, visible plastic deformation of the material.

For a paper, or paperboard, material such as would be typically used for a mailer, a reversible deflection may be achieved by avoiding the creation of too small a radius of curvature for any bend. The deflection may involve bending the material of the flap, and by ensuring that a minimum radius of curvature is never exceeded, the material will typically return to its original position without any significant evidence, particularly visible evidence, of the deflection. If the minimum radius of curvature is exceeded, then the material is likely to irreversibly crease, which is undesirable. It should be understood that the term irreversible here is used to indicate that the crease is not removed by simply returning the material to its original position. For example, it may be that removal of such a crease is either substantially impossible, or at least impractical or inefficient, in the manufacturing of a mailer.

The blank may be any suitable size and shape. The blank may be formed from a paper, or paperboard, material as noted above. The blank may include preformed creases, folds, scores or other weaknesses, along which it is anticipated that the blank will be folded, as this facilitates accurate automated folding during manufacture.

The envelope portion of the blank comprises a major portion that will ultimately form the first and second major surfaces. These surfaces may be joined by a fold line along a closed edge of the pouch. The major portion may be wider in a direction substantially parallel with the fold between the two major surfaces than the enclosure portion, as this will facilitate forming. It should be noted that this need not be the case, as additional forming could be applied to the enclosure portion, so that it fits within the pouch.

If the major portion is wider than the enclosure portion, or is at least wider after a pre-folding of the enclosure portion, the step of folding and securing the blank to form a pouch can be achieved by folding the enclosure portion end over end, until the joint is reached and the enclosure substantially overlies the first major surface, and then folding the major portion to form a fold between the first and second major portions, to thereby sandwich the enclosure between the first and second major portions. Edges of the first and/or second major portions may include an adhesive, such that, when they are pressed together, the edges are secured to one another and the pouch is formed. It should be understood that an adhesive may be pre-applied to the blank, or applied or activated during the folding and securing operation.

After the pouch has been formed, the joint between the envelope and the enclosure is arranged on the first major surface at or adjacent the opening of the pouch. The second major surface includes a closure flap for closing the pouch to seal the envelope, which extends away from the opening beyond the joint.

Although one side of the joint may be accessible, the flap substantially hinders, or prevents, access to the other side of the joint, and this makes severing the joint using cutters difficult without high precision tools.

Reversibly deflecting the flap away from the joint exposes the joint, in that it makes both sides of the joint more readily accessible, and thereby facilitates high speed cutting to sever the joint between the envelope and the enclosure. The severing may comprise cutting along a fold between the envelope and enclosure, or removing a portion of the envelope and enclosure that includes the joint. The cutting operation may also separate pages of the enclosure, if the enclosure portion of the blank included more than one page. The cutting operation may be performed by any suitable cutter, for example, rotary cutting blades, or one or more movable blades, such as a guillotine type arrangement. A guillotine arrangement may be particularly suitable if cutting through a layer, or layers, of paper, or paperboard, material with a total thickness greater than about 1.5 mm or greater than about 2 mm.

Once the joint is severed, the flap can be allowed to return, or can be returned, to its original configuration, and can be folded and secured, for example, using an adhesive, to the first major surface to close the pouch and seal the envelope. The adhesive on the flap may be pre-applied to the blank, or applied or activated during the processing of the blank, for example, during the folding and securing of the closure flap. The fold line between the flap and second major surface may be arranged beyond the first major surface, after severing of the joint to facilitate folding, and the deflection of the flap away from the joint may include deflection of the fold and a part of the second major surface.

The pouch, once formed, may be moved towards a cutter, and the reversible deflection of the flap may occur as a result of that movement. This simplifies the construction of apparatus to carry out the method, as the cutter can be fixed to the apparatus and the pouch moved towards it. Since the pouch is moving relative to the apparatus, it is possible to make use of a fixed (relative to the cutter) deflector, such that the deflection of the flap occurs essentially passively as the pouch moves towards the cutter. If the pouch is going to be moved, then it is efficient if that movement also causes an additional action to occur, as this prevents mis-timing of events, and also avoids the need for the location of the pouch to be accurately identified to allow a movable deflector to contact the flap before cutting.

The pouch may be moved towards the cutter on a conveyer belt, particularly a vacuum conveyor belt that uses perforated belt through which a vacuum is drawn to hold the pouch onto the conveyor. Alternatively, or additionally, rollers, or a further conveyor belt, may be used to press the pouch onto the conveyor belt.

As noted above, the movement of the pouch may cause the flap to contact and move along a deflector, thereby causing the deflection of the flap and any associated portion of the second major surface.

The deflector may comprise a trapping part and a deflecting part, or may comprise a deflecting part only. The trapping part may control an entry position of the flap into the deflecting part, and the deflecting part causes the deflection of the flap. If a trapping part is used, the deflecting part may be arranged between the trapping part and the cutter, so that as the pouch moves towards the cutter, the flap first encounters the trapping part, which controls the position of the flap, until it reaches the deflecting part. The deflecting part gradually deflects the flap, so that the deflection is substantially reversible, and moves the flap away from the joint to thereby expose the joint. The flap material is not rigid, and without a trapping portion, it is possible that the flexibility of the flap could, for example, as a result of vibration or a strong breeze, unexpectedly contact or fail to contact the deflector as anticipated, and therefore not be deflected as desired. This could cause some, or all, of the flap to be cut off, which would render the mailer unusable, or potentially create a jam in the apparatus later on.

The deflector comprises at least one shaped rod, along which the flap slides. The rod may have a substantially circular cross section. Using one or more rods, particularly rods with a circular cross section, reduces the contact area between the deflector and the flap, which reduces frictional forces that may be applied to the pouch via the flap. A reduction in the friction forces reduces the likelihood that the pouch may spin, or otherwise move, during the deflection of the flap, and also reduces the force required to move the flap relative to the deflector. It should be understood that a suitable deflector could be formed from any suitable materials, for example, a deflector could, if desired, be pressed and cut from a single sheet of material, rather than being formed by rods.

The first and second major surfaces of the pouch may be substantially planar, and may be substantially parallel with one another. This arrangement is simple to form and provides an arrangement like that of a traditional envelope.

The flap may be deflected, so that an end portion of the flap extends at substantially 90° to the plane of the first and second major surfaces. Although it should be understood that the flap is moved away from the joint to expose the joint, it is preferred that the flap is not deflected through too great an angle. The angle through which the flap is deflected may be less than about 135°, less than 100°, and is preferably substantially 90°. A deflection of about 90° allows a cutter to be employed that can extend perpendicular to the first and second sides, on both sides of the joint, and this increases the size of cutter that can be used, which can assist in high speed and high volume production.

During the cutting operation, at least a part of the flap may be directed out of a plane occupied by the first and second major surfaces. If the flap were to be folded flat onto the second major surface, it would expose the joint for cutting, but the fold between the flap and the second major surface would create a permanent crease, which would be visible on the finished mailer and may be considered unacceptable by some users. Depending upon the size of the flap, a portion may be folded back onto the second major surface, but to ensure that the deflection was reversible, a minimum radius of curvature of the material must not be exceeded, resulting in at least some of the flap being directed out of the plane of the first and second major surfaces.

Additional contents may be added onto the blank prior to the folding and securing operation. The additional contents may be located substantially within the pouch after the folding and securing step of the method. These additional contents could be, for example, generic advertising that is not specific to the addressee of the enclosure and the loss of which, or incorrect inclusion of which, would not be problematic.

Although the blank could be provided pre-cut, the blank may be cut from a web, or a sheet, of material. The web of material may be fed into a production machine, and then cut and formed into the required blank. Surfaces of the blank may be printed prior to being folded and secured.

The printing of the surfaces of the blank may take place while the material is still part of the roll, or web, or after separation of the blanks. The printing may include the printing of the name and address of the recipient on the envelope portion of the blank, and the printing of information on the enclosure portion.

The disclosure also provides apparatus for making a mailer from a blank, the blank comprising an envelope portion and enclosure portion, the envelope portion connected to the enclosure portion by a joint, the apparatus comprising a receiving section, a forming section a cutting section and a finishing section;

the receiving section being for receiving the blank;

the forming section having formers to fold and secure a received blank, such that the envelope portion forms a pouch, the pouch substantially containing the enclosure portion, the pouch being open at one end and having first and second major surfaces, the first major surface including the joint at or adjacent the open end, and the second major surface including a closure flap extending from the open end beyond the joint;

the cutting section including a deflector and a cutter, the deflector deflecting the flap away from the joint to thereby expose the joint so that the cutter can cut the joint while it is exposed; and

the finishing section comprising a closer to fold and secure the flap to the second major surface, to close the pouch and secure the enclosure within the pouch.

The cutting section may include means for moving the pouch formed in the forming section towards the cutter. The means for moving the pouch may comprise a conveyor, which may be a vacuum conveyor, but may comprise any other suitable means for moving the pouch, for example, movable grippers, such as vacuum grippers or mechanical grippers, movable platforms or similar. In an alternative embodiment, the cutter, or a portion of the cutter, might be moved toward the pouch, for example, in a guillotine type arrangement. If the pouch remains stationary with respect to the apparatus, then a movable deflector may be used to reversibly deflect the flap.

The apparatus may further comprise a content adding section, in which additional contents can be added onto the blank between the receiving section and leaving the forming section. The additional contents may be located substantially within the pouch after the folding and securing step of the method. The additional contents may be added following a forming step, in which the enclosure portion is folded, but prior to a forming step in which the envelope portion is folded.

As mentioned in the example above, the adding section may comprise any suitable apparatus for adding contents, for example friction feeders or windmill tip on devices.

The apparatus may include a web section in which a web of material is received and cut into a blank for transfer to the receiving section.

The apparatus may include a printing section including a printer for printing onto the web or blank before the blank is transferred to the forming section.

The apparatus may also include one or more optical sensors, for example, scanners, barcode readers, cameras, or the like, which are able to read indicia from the web, blank or elsewhere. The indicia may be indicative of at least one quality of the mailer to be formed, for example, it may include information about the number of pages that will make up the enclosure, or the size of the envelope. The indicia can be processed by a processor and the apparatus then configured to print, cut and form the appropriate mailer.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. A method of making a mailer including an envelope and an enclosure, the method comprising:
a) providing a blank comprising an envelope portion and an enclosure portion, the envelope portion connected to the enclosure portion by a joint;
b) folding and securing the blank such that the envelope portion forms a pouch, the pouch substantially containing the enclosure portion, the pouch being open at one end and having first and second major surfaces, the first major surface including the joint at or adjacent the open end, and the second major surface including a closure flap extending from the open end beyond the joint;
c) reversibly deflecting the flap away from the joint to thereby expose the joint;
d) severing the joint while it is exposed;
e) folding the closure flap and securing it to the first major surface to close the pouch and secure the enclosure within the pouch.

2. A method as claimed in claim 1, in which the pouch, once formed, is moved towards a cutter and the reversible deflection of the flap occurs as a result of that movement.

3. A method as claimed in claim 2, in which the pouch is arranged on a conveyor belt which moves the pouch.

4. A method as claimed in claim 3, in which the conveyor belt comprises a vacuum conveyor.

5. A method as claimed in claim 2, in which the movement of the pouch causes the flap to contact and move along a deflector, thereby causing the deflection of the flap.

6. A method as claimed in claim 5, in which the deflector comprises a trapping part and a deflecting part, the trapping part controlling an entry position of the flap into the deflecting part, and the deflecting part causing the deflection of the flap.

7. A method as claimed in claim 5, in which the deflector comprises at least one shaped rod along which the flap slides, the rod having a substantially circular cross section.

8. A method as claimed in claim 1, in which the first and second major surfaces are substantially planar and are substantially parallel with one another.

9. A method as claimed in claim 8, in which the flap is deflected so that an end portion of the flap extends at substantially 90° to the plane of the first and second major surfaces.

10. A method as claimed in claim 1, in which additional contents are added onto the blank prior to the folding and securing operation, the additional contents being located substantially within the pouch after the folding and securing step of the method.

11. A method as claimed in claim 1, in which the blank is cut from a web of material and includes printing prior to being folded and secured.

12. An apparatus for making a mailer from a blank, the blank including an envelope portion and an enclosure portion, the envelope portion connected to the enclosure portion by a joint, the apparatus comprising:
a receiving section, a forming section, a cutting section, and a finishing section;
the receiving section configured to receive the blank;
the forming section having formers that fold and secure the received blank, such that the envelope portion forms a pouch, the pouch substantially containing the enclosure portion, the pouch being open at an end and having first and second major surfaces, the first major surface including the joint at or adjacent the open end, and the second major surface including a closure flap extending from the open end beyond the joint;
the cutting section including a deflector and a cutter, the deflector configured to deflect the flap away from the joint and thereby expose the joint so that the cutter can cut the joint while it is exposed; and
the finishing section comprising a closer configured to fold and secure the flap to the first major surface to close the pouch and secure the enclosure within the pouch.

13. An apparatus as claimed in claim 12, in which the cutting section includes means for moving the pouch formed in the forming section towards the cutter.

14. An apparatus as claimed in claim 13, in which the moving means includes a conveyor belt configured to move the pouch formed in the forming section towards the cutter.

15. An apparatus as claimed in claim 14, in which the moving means includes a vacuum conveyor configured to move the pouch formed in the forming section towards the cutter.

16. An apparatus as claimed in claim 13, in which movement of the pouch towards the cutter causes the flap to contact and move along the deflector, and thereby causes the flap to deflect.

17. An apparatus as claimed in claim 16, in which the deflector comprises a trapping part and a deflecting part, the trapping part controls an entry position of the flap into the deflecting part, and the deflecting part causes the deflection of the flap.

18. An apparatus as claimed in claim 16, in which the deflector comprises at least one shaped rod along which the flap slides, the rod having a substantially circular cross section.

19. An apparatus as claimed in claim 12, in which the apparatus further comprises a content adding section configured to add contents onto the blank between the receiving section and the forming section, the contents being located substantially within the pouch with the flap folded and secured to the first major surface.

20. An apparatus as claimed in claim 12, in which the apparatus includes a web section configured to receive a web of material and cut the web of material into the blank for transfer to the receiving section, and in which the apparatus includes a printing section including a printer configured to print onto the blank before the blank is transferred to the forming section.
